(19) United States
(12) Patent Application Publication
(10) Pub. No.: US 2017/0000585 A1
(43) Pub. Date: Jan. 5, 2017

(54) STORAGE AND MIXING DEVICE FOR THE PRODUCTION OF A DENTAL PREPARATION AS WELL AS USE AND PROCESS FOR PRODUCING THE DEVICE

(71) Applicant: VOCO GmbH, Cuxhaven (DE)

(72) Inventors: Andree BARG, Otterndorf (DE); Manfred Thomas PLAUMANN, Cuxhaven (DE)

(73) Assignee: VOCO GmbH, Cuxhaven (DE)

(21) Appl. No.: 15/165,694

(22) Filed: May 26, 2016

(30) Foreign Application Priority Data
Jul. 2, 2015 (DE) 102015212394.4

(51) Int. Cl. A61C 5/06

(52) U.S. Cl. CPC A61C 5/068; A61C 5/066; A61C 5/064

(57) ABSTRACT

The invention concerns a storage and mixing device for producing a dental preparation comprising two, three or more mixing components, wherein the storage and mixing device has an individual chamber or two or more chambers which are separated from each other in a storage condition and which contain the mixing components, and an actuator moveable from a storage position for maintaining the storage condition of the storage and mixing device into a reaction position for bringing the mixing components together. In accordance with the invention it is proposed that a first and a second mixing component and optionally one or more further mixing components are already accommodated in the individual chamber or a first chamber of the plurality of chambers when the actuator is still in the storage position.

The present invention concerns a storage and mixing device for producing a dental preparation comprising two, three or more mixing components, wherein the storage and mixing device has an individual chamber or two or more chambers which are separated from each other in a storage condition and which contain the mixing components.

### BACKGROUND OF THE INVENTION

The term dental preparation in connection with the present invention is used to denote a multi-component system like for example an adhesive, filling material, cavity lining material, crown and bridge material, core build-up material, fixing material in general (in particular fixing cement) and glass ionomer. According to the invention an amalgam or an amalgam mix is not embraced by the term.

Storage and mixing devices of the kind set forth in the opening part of this specification serve the purpose of keeping the dental preparation when divided up into components storable over as long a period as possible. Mixing and application devices for dental preparations which for example are provided in the form of a two-component system are known for example from DE 10 2009 016 862 or DE 20 2011 005 121.

### SUMMARY OF THE INVENTION

The known mixing and/or application devices are used to store dental preparations in the form of two-component systems and in the situation of use to produce the dental preparation by bringing the components together. They have proved their worth in practice. There is however the desire to have to involve the lowest possible apparatus implementation for storage of the multi-component dental preparations. In addition the aim is in particular to permit an improvement in the storage stability of the dental preparations. Therefore the object of the invention was to provide for storage of multi-component dental preparations with the lowest possible level of apparatus involvement and in particular to permit an improvement in the storage stability of the dental material.

The invention attains its object in a storage and mixing device of the kind set forth in the opening part of this specification, in that a first and a second mixing component and optionally one or more further mixing components are already accommodated in the individual chamber or a first chamber of the two or more chambers. In other words the invention is based on the approach that a first number of (x) mixing components is stored in a storage and mixing device, in which respect for that purpose only a second number of (x−1) or fewer chambers is required. The consequence of this is that it is possible to improve storage stability by dividing the dental preparation up into a larger number of components and at the same time to keep the structural configuration of the storage and mixing device simple. In accordance with the invention the term storage and mixing device is always used to denote a device which is adapted both to bring the mixing components together and also to store the mixing components in their non-reacted storage condition. The subject of the invention is accordingly interpreted as a combined storage and mixing device, as distinct from pure mixers which are suited exclusively for mixing mixing components which are conveyed therethrough.

In an advantageous development of the invention the storage and mixing device has an actuator which is moveable from a storage position for maintaining the storage condition of the storage and mixing device into a reaction position for bringing the mixing components together, wherein the first and a second mixing component and optionally the one or more further mixing components are already accommodated in the individual chamber or in the first chamber of the two or more chambers when the actuator is still in the storage position.

In accordance with the invention the term actuator is used to mean a drive adapted to convert a drive energy acting thereon from the exterior into movement work. The actuator according to the invention is adapted by virtue of its movement to displace the mixing components arranged in the number of chambers.

The term mixing components is used to denote those substances or mixtures of substances which are provided as a starting material for reaction with a respective one or more further substances or mixtures of substances, for the production of a dental preparation.

Preferably, in addition to the above-mentioned functions the actuator is also adapted for expelling the dental preparation which occurs after the components have been brought together. The components are present in the chambers in the form of liquids, solids, in particular powder, or preferably in the form of pasty materials, wherein the term pasty material is used to denote a suspension of liquid and solid constituents.

The term chambers which are separated from each other in the storage condition denotes any arrangement of chambers in which, irrespective of the alignment of the chambers relative to each, there cannot be any communication of the chamber contents. In other words neither paste nor liquid can flow from one chamber into the other as long as they are separated.

A further advantageous development of the invention provides that the first and second mixing components are arranged separately from each other in the first chamber in the storage position of the actuator. The separation of the first and second mixing components makes it possible for even those mixing components which upon contact with each other would be involved in a reaction to be stored jointly with each other in a chamber.

Preferably the first and second mixing components are arranged spatially separated from each other in the storage position of the actuator, preferably adhering to mutually spaced portions of the chamber wall.

The rheological properties of the first and second mixing components are preferably ascertained in preliminary tests, in which respect in particular the viscosity and flow limit of the first and second mixing components should be so selected that after application to the respective portion of the chamber wall the mixing components remain adhering there and both do not slide down on the chamber wall in an orientation of the corresponding portions of the chamber wall parallel to the field of gravity of the earth and also do not detach from the chamber wall upon vertical orientation relative to the field of gravity of the earth, that is to say hanging freely on the chamber wall. Preferably the above-mentioned properties are so selected and are so adapted to the surface of the chamber wall of the storage and mixing device that predefined accelerations and decelerations do not result in detachment of the mixing components from the chamber wall.

For example the adhesion behaviour of the mixing components can be tested by mounting and slowly rotating the storage and mixing device about three mutually perpendicular axes. Preferably, in certain predetermined orientations of the mixing components, in particular hanging freely down from the adhesion portion associated therewith and/or with a perpendicularly oriented adhesion portion, the movement of the storage and mixing device can be stopped and retained for a predefined residence time. An acceleration test can be performed for example by the filled storage and mixing device being dropped from a predefined height, for example approximately in the region of between 0.25 and 0.5 m, on to a solid surface. Those drop tests can optionally also be repeated a plurality of times.

The first and/or second mixing component is preferably in the form of a paste. Preferably the first and/or second mixing component has its yield limit at a shear stress of 1 Pa or more, particularly preferably 5 Pa or more. Further preferably the first and/or second mixing component has its flow limit at a shear stress of 50 Pa or more. In this respect the term yield limit is used to denote that shear stress which acts on the mixing components and below which the paste behaves in a reversibly-viscoelastic fashion. In this respect the term flow limit is used to denote that limit, above which the internal structure of the mixing component is collapsed to such an extent that it begins to flow under the shear stress. The yield and flow limits are preferably determined by means of an amplitude sweep with a rheometer like for example a type MCR301 from Anton Paar.

In a further preferred embodiment the first and second mixing components are selected as mixing components which chemically react with each other and whose reaction product has a reduced diffusion coefficient for the first and second mixing components. The result of this is that, upon contact between the two mixing components, an interface is formed, along which a chemical reaction takes place. It will be noted however that due to the reaction itself, a passive layer is produced, which extends along the entire interface and which causes difficulty in diffusion of the respective mixing components through to the other side or in the best-case scenario completely prevents that. That makes it possible for the mixing components to be arranged in directly mutually adjoining relationship in the same chamber as they automatically bring about separation by means of passivation.

In those embodiments in which spatial separation is not required by virtue of the composition of the mixing components as described above it is preferred that the first and second mixing components in the storage position of the actuator are arranged in immediately mutually adjoining relationship in the first chamber.

In addition to the first chamber which contains the first and second mixing components the storage and mixing device further preferably has a second chamber, wherein a third mixing component is accommodated in the second chamber when the actuator is still in the storage position. In a first preferred alternative the actuator is adapted by means of its movement from the storage position into the reaction position to displace the third mixing component out of the second chamber into the first chamber, or alternatively to displace the first and second mixing components out of the first chamber into the second chamber. In that way all three components are brought together in one of the two chambers in order to cause production of the dental preparation in a chemical reaction. Optionally the implementation of a shaking movement and/or a rotational and/or pivotal movement and/or the supply or removal of thermal energy from the exterior can be used in support.

In such a configuration as described above the storage and mixing device is preferably in the form of a mixing and/or application capsule.

Preferably in that case the actuator is in the form of a plunger and has a first latching position in the storage position and a second latching position in the reaction position. In that way it is easier for the operator by means of a haptic feedback to move the plunger into the reaction position without by mistake moving the plunger out of its latching position in the storage position when the storage and mixing device is not yet intended for use.

Further preferably the actuator is moveable from the reaction position into a third position for dispensing the combined mixing components. That is preferred in particular when the storage and mixing device is to be used as a mixing and application capsule.

In a second preferred alternative the first chamber has a first outlet opening and the second chamber has a second outlet opening, wherein the actuator is adapted upon a movement from the storage position into the reaction position to convey the first and second mixing components through the first outlet opening and the third mixing component through the second outlet opening.

Preferably in such a configuration the storage and mixing device has an injection cartridge, within which the first and second chambers are arranged, wherein the actuator is in the form of a multiple plunger which has a plunger body for each of the chambers of the injection cartridge. A storage and mixing device according to this embodiment can have a double cartridge or a cartridge with more than two chambers as the invention generally also concerns storage and mixing devices for systems comprising four or more components.

The injection cartridge can preferably be connected in fluid-conducting relationship to a mixing chamber, preferably to a mixing chamber of a static mixer. In a preferred development the static mixer is also a constituent part of the storage and mixing device according to the invention so that the injection cartridge is then connected to the static mixer.

In a further preferred embodiment of the invention, one or more further mixing components are additionally already arranged in the first mixing chamber when the actuator is still in the storage position. The arrangement of the mixing components is preferably similar to the features in respect of the first and second mixing components from the above-described embodiments. If the mixing chamber is of a sufficient size the one or more further mixing components are preferably also arranged selectively separated from each other or arranged directly adjoining a respective one or more of the further mixing components. In that respect attention is directed to the foregoing description for the avoidance of repetition.

In a further preferred embodiment of the invention in addition to the first chamber the storage and mixing device also has one or more further chambers in which two or more mixing components are respectively already arranged when the actuator is still in the storage position. The one or more further chambers are also preferably designed in accordance with the features in respect of the first chamber and/or the second chamber in the above-described preferred embodiments. In that respect attention is directed to the foregoing description for the avoidance of repetition.

In a second aspect the invention also concerns a process for producing a storage and mixing device for the production of a dental preparation from two, three or more mixing components.

The object of the invention in the second aspect, taking a storage and mixing device of the kind set forth in the opening part of this specification as the basic starting point, is that of providing a process for the production of the device, with which an improvement in storage stability of the dental material is to be achieved with the simplest possible means.

The invention attains its object by the process including the steps:
introducing a first mixing component into a first chamber of the storage and mixing device, and
introducing a second mixing component into the first chamber.

The process makes use of the same advantages and approaches as the invention in accordance with the first aspect and has the same preferred embodiments. In that respect attention is directed to the foregoing description in relation to the first aspect.

The process preferably further includes the step:
inserting an actuator moveable from a storage position for maintaining the storage condition of the storage and mixing device into a reaction position for bringing the mixing components together into the storage and mixing device in the storage position.

A further preferred development of the process provides that the first and second mixing components are arranged in mutually separated relationship in the first chamber, preferably spatially separated from each other, particularly preferably adhering to mutually spaced portions of the chamber wall.

In a further preferred embodiment the first and second mixing components are arranged in directly mutually adjoining relationship in the first chamber.

Preferably the first and second mixing components are selected as mixing components which chemically react with each other and whose reaction product has a reduced diffusion coefficient for the first and second mixing components.

Preferably the process further includes the step:
introducing a third mixing component into a second chamber of the storage and mixing device, wherein the second chamber is separated from the first chamber in the storage position of the actuator.

In a third aspect the invention also concerns the use of a storage and mixing device for producing a dental preparation from a first number of mixing components.

The objects already set forth in relation to the first two aspects are attained by the invention in that the storage and mixing device has a second number of chambers which are separated from each other in a storage condition and which contain the mixing components, and preferably an actuator which is moveable from a storage position for maintaining the storage condition of the storage and mixing device into a reaction position for bringing the mixing components together, wherein the second number is smaller than the first number at least by one. In particular the storage and mixing device is designed in accordance with one of the above-described preferred embodiments and can preferably be produced by means of the process according to one of the above-described preferred embodiments.

### BRIEF DESCRIPTION OF THE SEVERAL VIEWS OF THE DRAWINGS

The invention is described in greater detail hereinafter by means of preferred embodiments by way of example and with reference to the accompanying Figures in which:

FIGS. 1a shows a storage and mixing device according to a first embodiment in the opened position,

FIGS. 1b shows a storage and mixing device according to a first embodiment in the reaction position,

FIGS. 1c shows a storage and mixing device according to a first embodiment in the dispensing position, FIG. 2a shows a storage and mixing device according to a second embodiment an operating state,

FIG. 2b shows an storage and mixing device according to a second embodiment in a different operating state, and

FIG. 3 shows a graph illustration of the behaviour in respect of change in form of various mixing components.

### DETAILED DESCRIPTION OF THE INVENTION

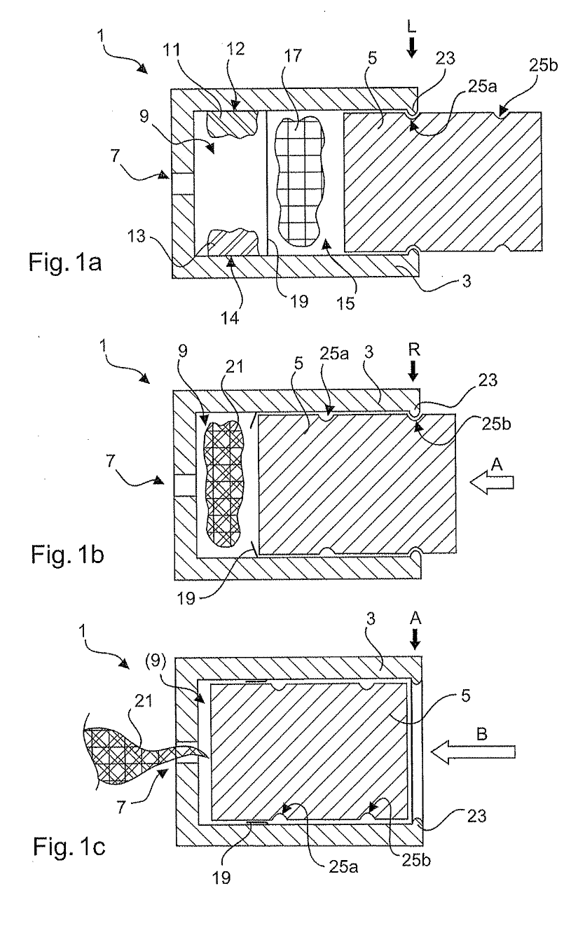

The storage and mixing device 1 shown in FIG. 1a-c is in the form of a mixing capsule. It has a capsule body 3 in which an actuator 5 in the form of a plunger is linearly moveably guided. The storage and mixing device 1 has an outlet opening 7 through which, in the opened condition, the product of the reaction of the mixing components can issue from a first chamber 9. A first mixing component 11 and a second mixing component 13 are disposed in the first chamber 9. The first mixing component 11 and the second mixing component 13 are spatially separated from each other. The first mixing component 11 adheres to a first portion 12 of a wall of the first chamber while the second mixing component 13 adheres to a second portion 14, spaced from the first portion 12, of a wall of the first chamber.

The storage and mixing device 1 further has a second chamber 15 which is separated from the first chamber 9, for example by a separating means 19 which for example can be in the form of a film. A third mixing component 17 is arranged in the second chamber 15.

The actuator 5 has a first latching means 25a which for example can be in the form of a peripherally extending recess. The capsule body 3 has a correspondingly configured latching means 23 which for example can be in the form of a peripherally extending projection. The corresponding latching means 23, 25a cooperate in such a way that they are in operatively connected relationship in the storage position L shown in Figure is and give the operator a haptic feedback when the operative connection is released. A positively locking engagement of the latching means 23, 25a into each other is shown in the embodiment in FIGS. 1a-c. Alternatively a force-locking or frictional engagement would also be conceivable. The latching force exerted by the latching means 23, 25a of corresponding configuration prevents an operator unintentionally moving the actuator 5 out of the storage position L.

The actuator 5 further has a second latching means 25b which for example can be in the form of a peripherally extending recess. In the reaction position R shown in FIG. 1b the corresponding latching means 23, 25b of the capsule body 3 and the actuator 5 respectively are disposed in operatively connected relationship with each other, preferably with the same effect as the latching means 23 and 25a in FIG. 1a.

The actuator 5 is shown in a dispensing position A in FIG. 1c. The dispensing position A can be selectively achieved by the actuator 5 being brought to bear completely against the wall portion having the outlet opening 7, or held by further latching means (not shown) in the illustrated position, depending on the respective configuration of the storage and mixing device. The aim generally should be to dispense as much material as possible from the remaining part of the first chamber 9 of the storage and mixing device 1.

As can be seen from FIGS. 1b and is in comparison with FIG. 1a the actuator 5 is adapted to displace the third mixing component 17 out of the second chamber 15 and transfer it into the first chamber 9, for example by overcoming the separating means 19, in particular by the destruction thereof, if the separating means 19 for example is in the form of a film.

In the position shown in FIG. 1b, in which the actuator 5 has been moved into its reaction position in the direction of the arrow A, a dental preparation 21 has been produced by chemical reaction of the three components 11, 13 and 17, and the dental preparation can now be dispensed from the first chamber 9 through the outlet opening 7.

FIG. 1c is shows that dispensing operation. Starting from the reaction position in FIG. 1b the actuator 5 has been further moved in the direction of the arrow B and the dental preparation 21 has been conveyed out of the first chamber 9. Optionally, it is possible to fluid-conductingly connect to the outlet opening 7 an application cannula (not shown), by means of which the dental preparation can be directly applied.

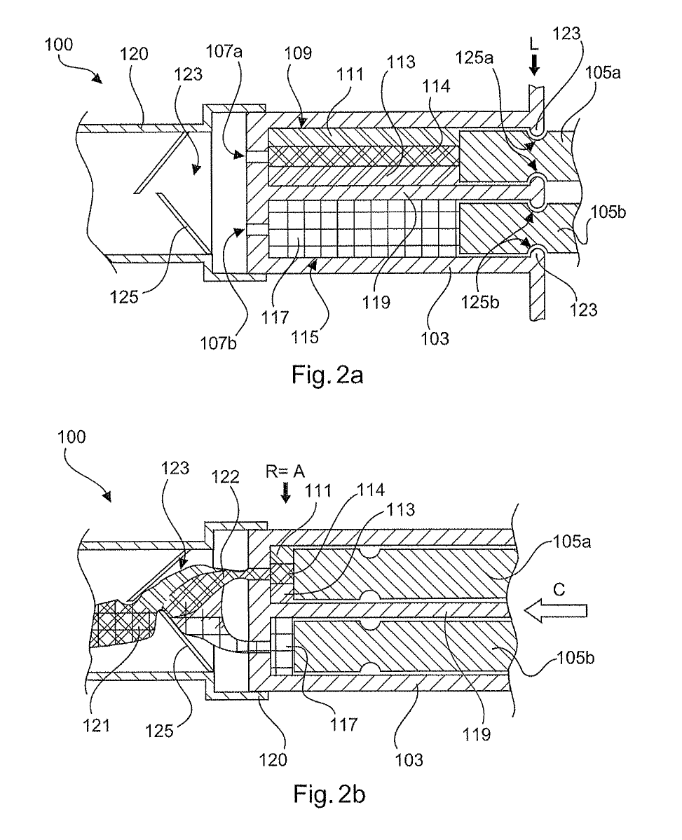

While in the first embodiment the storage and mixing device 1 has been shown in the form of a mixing capsule FIGS. 2a,b show a further embodiment of the concept according to the invention. The storage and mixing device 100 of the second embodiment has an injection cartridge 103. The injection cartridge 103 has a first chamber 109 and a second chamber 115. A plunger body 105a is linearly moveably guided in the first chamber 109 while a second plunger body 105b is linearly moveably guided in the second chamber 115. Preferably the plunger bodies 105a and 105b are coupled together in such a way that they are moveable synchronously to simultaneously empty the contents of both chambers 109, 115 upon actuation.

A first mixing component 111 and a second mixing component 113 are arranged in the first chamber 109. An interface is formed between the two mixing components 111, 113. If the two mixing components 111, 113 are substances which are chemically reactive with each other, in accordance with one of the above-described embodiments, whose reaction product has a reduced diffusion coefficient in respect of the respective mixing components 111, 113, a passive layer 114 is formed.

A third mixing component 117 is arranged in the second chamber 115.

The first chamber 109 has a first outlet opening 107a. The second chamber 115 has a second outlet opening 107b. In the opened condition the outlet openings 107a, 107b are fluid-conductingly connected to a third chamber, namely the mixing chamber 123 of a static mixer 120. In addition disposed in the mixing chamber 123 of the static mixer 120 are a plurality of mixing elements 125 for mixing the mixing components 111, 113, 117 stored in the chambers 109, 115.

The first and second chambers 109, 115 are permanently separated from each other by means of a separating wall 119.

The storage and mixing device 100 has a latching means 123 which in the position shown in FIG. 2a is operatively connected to corresponding latching means 125a, b of the actuator 105a, b. In regard to the mode of operation of the corresponding latching means 123, 125a, b attention is directed to the description relating to the corresponding latching means 23, 25a, b in FIGS. 1a-c.

Unlike the embodiment in FIGS. 1a-c, upon actuation of an actuator 105a, b the content of one of the two chambers 109; 115 is not transferred into the respective other chamber 109; 115, but the contents of both chambers 109, 115 are simultaneously transferred into a third chamber, namely the mixing chamber 123, and are there mixed to give a dental preparation 121 by means of the mixing elements 125. Upon a movement of the actuator 105a, b, indicated by the arrow C, not just mixing of the components 111, 113, 117 themselves occurs in the mixing chamber 123, but in addition a passive layer possibly formed in the meantime in the first chamber 109 is also intermixed, indicated by reference 122. When using suitably selected mixing components 111, 113 in the first chamber 109, the static mixer 120 even makes it possible for the passive layer 114 possibly formed at the interface to be mixed in to such an extent that it completely reacts jointly with the third mixing component 117 or at least after passing through the mixing chamber 123 is no longer visible in the dental preparation 121 discharged from the static mixer 120.

As is shown from the foregoing description, in particular in comparison with the embodiments described with respect to the Figures, in spite of the differing structural configuration, both embodiments make use of the same realization, namely disposing more than one component in at least one of the chambers of the storage and mixing device affords unexpected advantages in regard to storage stability without having to design the structural configuration of the storage and mixing device itself in a more complicated fashion.

The invention will be further described in respect of its physical/chemical aspects by means of the following two Examples.

The composition of the tested multi-component systems is set out below. The meanings of the abbreviations are as follows:
UDMA urethane dimethacrylic acid ester (1,6-bis[2-methacryloyloxyethoxy-carbonyl-amino]-2,4,4-trimethyl hexane)
GDMA glycerol dimethacrylate
HPMA hydroxy propyl methacrylate
Bis-GMA 2,2-bis[4-(2-hydroxy-3-methacryloyloxy propoxy)phenyl] propane
EBADMA ethoxylated bisphenol-A-dimethacrylate
TEDMA triethylene glycol dimethacrylate
HP-phosphate phosphoric acid ester of hydroxy propyl methacrylate
BPO benzoyl peroxide
Bis-HEPToluidine N,N-bis(hydroxyethyl)paratoluidine (N,N-dihydroxyethyl-p-toluidine)
NaTS sodium toluene sulfinate
CQ camphorquinone
DABE N,N-dimethyl amino benzoic acid ethyl ester
BHT butyl hydroxyl toluene, and
Aerosil fumed silicate

In following Table 1 the line “Ratio” denotes the proportion by mass of the respective mixing component (paste) in relation to the proportions by mass of the further mixing component in the mixture which can be obtained by bringing the mixing components together. The lines in the Table following the line “Ratio” specify the percentage proportions of the individual mixture constituents in relation to the respective mixing component (columns “Cat paste”, Base paste”) and the mixture formed (column “Mixture”), in relation to the total mass of the respective mixing component or the mixture formed.

### Example 1

The multi-component system of the first Example is a fixing composite. The composition of the mixing components of the fixing composite and the mixture which can be obtained by bringing the mixing components together in the specified mass ratio are set out in the following Table.

The fixing composite of the Example is a two-component system whose first mixing component (cat paste) and second mixing component (base paste) can be arranged in a single chamber or in a first chamber of a plurality of chambers. In the latter case for example a coloring agent can be arranged as the third mixing component in a second chamber.

The dental glass 1 used is an acid-inert glass of an average particle size of 0.7 μm. The dental glass 2 is a barium-boron-aluminum silicate glass of an average particle size of 3.5 μm. The operation of determining the size of the particles is preferably effected by means of light scatter (laser diffraction), for example with a Beckmann Coulter LS 13320 particle size measuring device.

Aerosil 1 is a rather thixotropic-action silica like R 812S and Aerosil 2 is a rather thickening-action silica like R 709.

TABLE 1

| | Chamber 1 | Chamber 1 | |
|---|---|---|---|
| | Cat paste | Base paste | Mixture |
| Ratio | 1 | 1 | |
| UDMA | 3.74 | 8.21 | 5.97 |
| GDMA | 6.58 | 10.05 | 8.32 |
| HPMA | 3.88 | 4.13 | 4.01 |
| Bis-GMA | 6.51 | 5.49 | 6.00 |
| EBADMA | 0.99 | 2.17 | 1.58 |
| TEDMA | 0.94 | 2.07 | 1.51 |
| HP-phosphate | 10.00 | 0.00 | 5.00 |
| Aerosil 1 | 5.00 | 5.00 | 5.00 |
| Aerosil 2 | 3.50 | 3.00 | 3.25 |
| Dental glass 1 | 46.18 | 46.18 | 46.18 |
| Dental glass 2 | 11.16 | 11.66 | 11.41 |
| BPO | 1.45 | 0.00 | 0.73 |
| Bis-HEPToluidine | 0.00 | 1.00 | 0.50 |
| NaTS | 0.00 | 0.75 | 0.38 |
| CQ | 0.00 | 0.09 | 0.05 |
| DABE | 0.00 | 0.14 | 0.07 |
| BHT | 0.06 | 0.06 | 0.06 |
| | 100.00 | 100.00 | 100.00 |

### Example 2 and Comparative Example

The multi-component systems of Example 2 and the comparative Example are fixing composites. The composition of the mixing components of those fixing device composites and the mixture which can be respectively obtained by bringing the mixing components together in the specified mass ratio are listed in Table 2. The mixtures formed by bringing together the mixing components of Example 2 and the comparative Example respectively are of the same composition.

The fixing composite of Example 2 is a three-component system whose first and second components (paste 1, paste 2) are disposed in the first chamber of a storage and mixing device according to the invention and whose third mixing component (paste 3) is accommodated in the second chamber of a storage and mixing device according to the invention.

The fixing composite of the comparative Example is a two-component system whose first mixing component (paste V1) is accommodated in the first chamber and whose second mixing component (paste V2) is accommodated in the second chamber of a storage and mixing device including two chambers. The mixtures formed by bringing together the mixing components of Example 2 and the comparative Example respectively are of the same composition.

In following Table 2 the line “Ratio” denotes the proportion by mass of the respective mixing component (paste) in relation to the proportions by mass of the further mixing components in the mixture which can be obtained by bringing the mixing components together. The lines in Table 2 following the line “Ratio” are the percentage proportions of the individual constituents of the mixture in respect of the respective mixing component (columns “Paste 1”, “Paste 2”, “Paste 3”) and the mixture formed (column “Mixture”), in relation to the total mass of the respective mixing component and the mixture formed.

TABLE 2

| | Example 2 | | | | Comparative example | | |
|---|---|---|---|---|---|---|---|
| | Chamber 1 | | Chamber 2 | | Chamber 1 | Chamber 2 | |
| | Paste 1 | Paste 2 | Paste 3 | Mixture | Paste V1 | Paste V2 | Mixture |
| Ratio | 1 | 1 | 1 | | 1 | 1 | |
| UDMA | 20.00 | 20.00 | 10.00 | 16.67 | 11.80 | 21.54 | 16.67 |
| GDMA | 10.00 | 10.00 | 5.00 | 8.33 | 5.90 | 10.77 | 8.33 |
| HPMA | 5.00 | 5.00 | 5.00 | 5.00 | 3.54 | 6.46 | 5.00 |
| HP-phosphate | | | 30.00 | 10.00 | 20.00 | | 10.00 |
| BHT | 0.10 | 0.10 | 0.10 | 0.10 | 0.10 | 0.10 | 0.10 |
| Aerosil 1 | 5.00 | 5.00 | 2.00 | 4.00 | 4.00 | 4.00 | 4.00 |
| Aerosil 2 | 1.50 | 1.50 | 5.00 | 2.67 | 2.67 | 2.67 | 2.67 |
| Dental glass 1 | 18.40 | 18.20 | 39.90 | 25.50 | 51.00 | | 25.50 |
| Dental glass 2 | 38.50 | 38.00 | | 25.50 | | 51.00 | 25.50 |
| BPO | 1.50 | | | 0.50 | 1.00 | | 0.50 |
| Bis-HEPToluidine | | | 2.00 | 0.67 | | 1.33 | 0.67 |
| NaTS | | 1.50 | | 0.50 | | 1.00 | 0.50 |
| CQ | | 0.70 | | 0.23 | | 0.47 | 0.23 |
| DABE | | | 1.00 | 0.33 | | 0.67 | 0.33 |
| Total | 100.0 | 100.0 | 100.0 | 100.0 | 100.0 | 100.0 | 100.0 |

| | | | | |
|---|---|---|---|---|
| Material | initial | 1 month | 2 months | 3 months |

Setting time upon storage at 37° C. (seconds)

| | | | | |
|---|---|---|---|---|
| Example 2 | 180 | 182 | 183 | 183 |
| Comparative example | 176 | 190 | 205 | 225 |

Adhesion CC upon storage at 37° C. in MPa

| | | | | |
|---|---|---|---|---|
| Example 2 | 12.4 | 12.2 | 12.0 | 12.2 |
| Comparative example | 12.6 | 9.9 | 8.5 | 7.3 |

Bending strength CC upon storage at 37° C. (MPa)

| | | | | |
|---|---|---|---|---|
| Example 2 | 111 | 112 | 113 | 110 |
| Comparative example | 112 | 109 | 103 | 90 |

The abbreviation “CC” denotes “chemical curing” and states that the composition is hardened exclusively “chemically” (and not also photochemically) after mixing of the components.

Adhesion is determined in accordance with ISO/TS 11405.

The bending strength is determined in accordance with DIN EN ISO 4049: 2010-03, section 7.11,2.1.

The setting time is determined in accordance with DIN EN ISO 4049; 2010-03, section 7.7.

With storage and mixing devices according to the invention, for three-component systems, it is possible to achieve a comparably high level of storage stability as with storage devices in which each mixing component of the three-component system is stored in an individual chamber and the components would be mixed by hand.

In principle multi-component dental compositions can always be mixed together by hand. A disadvantage with hand mixtures in comparison with mixtures from devices is the risk of an inaccurate mixing ratio, the risk of air bubbles which are mixed in, a longer mixing time, a shorter processing time and an overall increased susceptibility to faults.

Thus improvements in storage stability and the properties entailed therewith for the dental material are linked with the storage and mixing devices according to the invention in comparison with the 2-component storage and mixing devices from the state of the art and also hand mixing systems.

The mixing components of the second Example were also investigated by way of example in regard to their rheological properties. To determine the yield limit and the flow limit of the mixing components the latter were tested in a rheometer of type MCR 301 from Anton Paar. The measuring system PP25 was used. The measurements were carried out at a temperature of 23° C.

The unit was operated in an oscillation mode in which a measurement body transmits a harmonic oscillation to the mixing component as the sample.

For carrying out the measuring method a respective mixing component was uniformly distributed flat between two plates. The mixing component was subjected to the action of the above-indicated harmonic oscillation by a measuring body. A value of 1.00 mm is predetermined as the maximum gap spacing between the two plates. With a constant annular frequency for the harmonic oscillation, in the present embodiment 10 rad/s, the amplitude of the oscillation movement is performed over a deformation range of between 0.01 and 100%. The deformation is equal to the quotient of amplitude and maximum gap spacing.

When introducing the above-identified parameters two curves were obtained in measurement for each mixing component. In that case a first curve is respectively representative of the storage modulus G′ and a second curve is representative of the so-called loss modulus G″. The storage modulus identifies the elastic proportion in change in form of the mixing component while the loss modulus identifies the plastic proportion of the change in form.

With low deformation levels the mixing component behaves reversibly-viscoelastically in a linear range. There is no significant change in the sample structure as a result of the deformation. The last measurement point at which the storage modulus G′ just still does not deviate from the range which previously was still approximately linear is referred to as the yield limit. When the yield limit is exceeded the mixing component will firstly always still have a gel-like character, although irreversibly changed under the influence of the shear stress. The loss modulus G″ and the storage modulus G′ approximate to each other. The intersection between the curves of the respective loss modulus G″ and the storage modulus G′ identifies the flow limit. Beyond that flow limit, by virtue of the greatly differing behaviour in respect of change in form of the mixing component, this is no longer to be referred to as a viscoelastic characteristic.

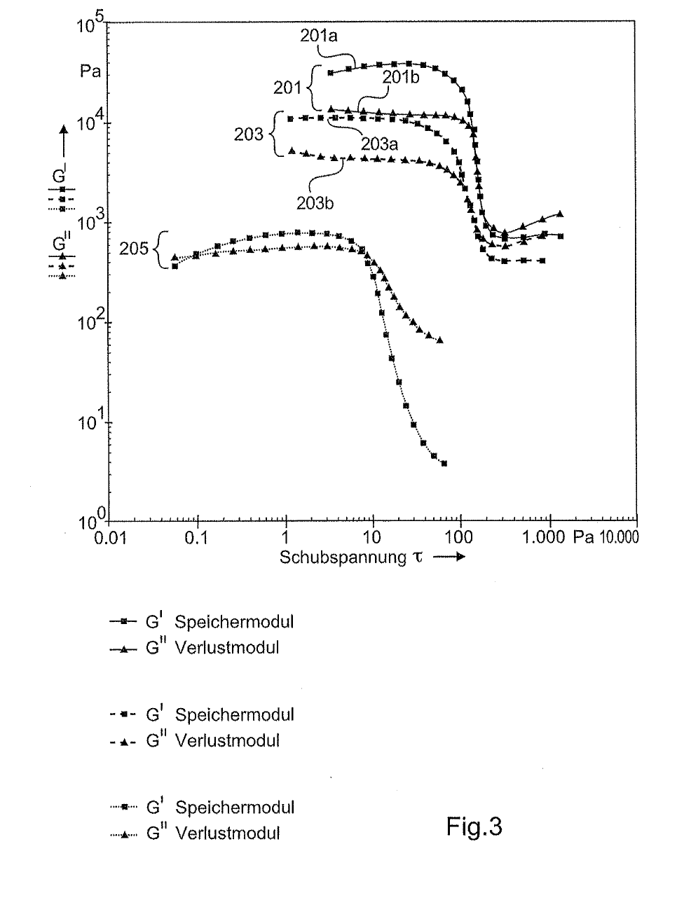

FIG. 3 shows by way of example for Example 2 the ascertained parameters for the three mixing components. In this case a first pair of curves 201 represents the first mixing component (paste 1). A second pair of curves 203 represents the second mixing component (paste 2). For the sake of completeness the third mixing component (paste 3) which is to be stored in the second mixing chamber is also shown and represented by a third pair of curves 205.

The first pair of curves has a storage modulus 201a and a loss modulus 201b. The curves of the pairs 201, 203, 205 are shown for the sake of clarity only as from attaining the yield limit which for the first mixing component occurs at a shear stress of about 3.5 Pa. The flow limit is at a shear stress of 150 Pa.

The second mixing component has a storage modulus 203a and a loss modulus 203b. The yield limit for the second mixing component is at a shear stress of somewhat above 1 Pa.

The flow limit for the second mixing component is somewhat below the flow limit of the first mixing component, but still at a shear stress of above 100 Pa.

It will be clear in comparison to the first and second mixing components that the third mixing component, identified by the pair of curves 205, is not suitable for storage in the first chamber. On the one hand, in its case the maximum distance between loss modulus and storage modulus is comparatively slight, on the other hand the yield limit is already reached at a very much lower shear stress of below 0.1 Pa.

In contrast thereto, for the suitability of a mixing component for storage with another mixing component jointly in one chamber, the aim is to provide that the storage modulus differs as much as possible from the loss modulus, at any event upon attaining the yield limit. That ensures a greater possible change in form until the flow limit is reached.

Thus, in the case of the first and second mixing components, by reference to the pairs of curves 201, 203, it is to be clearly understood that when the yield limit is reached the storage modulus is markedly higher than the loss modulus, and that that distance remains almost constant over a comparatively wide shear stress range until finally it abruptly falls when the storage modulus G′ and the loss modulus G″ approach the flow limit.

1. A storage and mixing device (1, 100) for producing a dental preparation (21, 121) comprising two, three or more mixing components (11, 13, 17; 11, 113, 117), wherein the storage and mixing device
has an individual chamber or two or more chambers (9, 15; 109, 115) which are separated from each other in a storage condition and which contain the mixing components (11, 13, 17; 111, 113, 117),
wherein a first and a second mixing component (11, 13; 111, 113) and optionally one or more further mixing components are already accommodated in the individual chamber or a first chamber (9, 109) of the two or more chambers.

2. The storage and mixing device as set forth in claim 1 comprising an actuator (5, 105a, b) which is moveable from a storage position for maintaining the storage condition of the storage and mixing device into a reaction position for bringing the mixing components (11, 13, 17; 111, 113, 117) together,
wherein the first and a second mixing component (11, 13; 111, 113) and optionally the one or more further mixing components is already accommodated in the individual chamber or in the first chamber (9, 109) of the two or more chambers when the actuator (5, 105a, b) is still in the storage position.

3. The storage and mixing device (1, 100) as set forth in claim 2, wherein the first and second mixing components (11, 13; 111, 113) are arranged separately from each other in the first chamber (9, 109) in the storage position of the actuator (5, 105a, b).

4. The storage and mixing device and mixing device (1) as set forth in claim 3, wherein the first and second mixing components (11, 13) are arranged spatially separated from each other in the storage position of the actuator (5), adhering to mutually spaced portions (12, 14) of the chamber wall.

5. The storage and mixing device (1, 100) as set forth in claim 1, wherein the first and second mixing components (11, 13; 11, 113) are selected as mixing components which chemically react with each other and whose reaction product has a reduced diffusion coefficient for the first and second mixing components (11, 13; 111, 113).

6. The storage and mixing device (100) as set forth in claim 5, wherein the storage position of the actuator (105a, b) the first and second mixing components (111, 113) are arranged in directly mutually adjoining relationship in the first chamber (109).

7. The storage and mixing device (1, 100) as set forth in claim 1, wherein a third component (17, 117) is accommodated in a second chamber (15, 115) which in the storage position of the actuator is separated from the first chamber, when the actuator (5, 105a, b) is still in the storage position.

8. The storage and mixing device (1) as set forth in claim 7, wherein the actuator (5) is adapted by means of its movement from the storage position into the reaction position
to displace the third mixing component (7) out of the second chamber (15) into the first chamber (9), or
to displace the first and second mixing components out of the first chamber into the second chamber.

9. The storage and mixing device (1) as set forth in claim 1, wherein the storage and mixing device is in the form of a mixing and/or application capsule.

10. The storage and mixing device (1) as set forth in claim 8, wherein the actuator (5) is in the form of a plunger and has a first latching position in the storage position and a second latching position in the reaction position.

11. The storage and mixing device (1) as set forth in claim 10 wherein the actuator (5) is moveable from the reaction position into a third position for dispensing the combined mixing components (11, 13, 17).

12. The storage and mixing device (100) as set forth in claim 7, wherein the first chamber (109) has a first outlet opening (107a) and the second chamber (115) has a second outlet opening (107b) and that the actuator (105a, b) is adapted upon a movement from the storage position into the reaction position to convey the first and second mixing components (111, 113) through the first outlet opening (107a) and the third mixing component (117) through the second outlet opening (107b).

13. The storage and mixing device (100) as set forth in claim 12, wherein the storage and mixing device has an injection cartridge (103), within which the first and second chambers (109, 115) are arranged, wherein the actuator (105a, b) is in the form of a multiple plunger which has a plunger body for each of the chambers (109, 115) of the injection cartridge (103).

14. The storage and mixing device (100) as set forth in claim 13, wherein the injection cartridge (103) can be connected in fluid-conducting relationship to a mixing chamber (123) of a static mixer (120).

15. The storage and mixing device as set forth in claim 1 and comprising one or more further chambers in which two or more mixing components are respectively already arranged when the actuator is still in the storage position.

16. A process for producing a storage and mixing device for producing a dental preparation from two, three or more mixing components, including the steps:
introducing a first mixing component (11, 111) into a first chamber (9, 109) of the storage and mixing device (1, 100), and
introducing a second mixing component (13, 113) into the first chamber (9, 109).

17. The process as set forth in claim 16 including the step:
inserting an actuator (5, 105a, b) moveable from a storage position for maintaining the storage condition of the storage and mixing device (1, 100) into a reaction position for bringing the mixing components together into the storage and mixing device (1, 100) in the storage position.

18. The process as set forth in claim 16, wherein the first and second mixing components (11, 13; 111, 113) are arranged in mutually separated relationship in the first chamber (9, 109), spatially separated from each other, adhering to mutually spaced portions of the chamber wall.

19. The process as set forth in claim 16, wherein the first and second mixing components (11, 13; 111, 113) are selected as mixing components which chemically react with each other and whose reaction product has a reduced diffusion coefficient for the first and second mixing components.

20. The process as set forth in claim 19, wherein the first and second mixing components (11, 13; 111, 113) are arranged in directly mutually adjoining relationship in the first chamber (9, 109).

21. The process as set forth in claim 16 including the step:
introducing a third mixing component (17, 117) into a second chamber (15, 115) of the storage and mixing device (1, 100), wherein the second chamber (15, 115) is separated from the first chamber (9, 109) in the storage position of the actuator (5, 105a, b).
